(19) United States
(12) Patent Application Publication
(10) Pub. No.: US 2016/0368348 A1
(43) Pub. Date: Dec. 22, 2016

(54) Thermal Fluid-Conditioning Device For A Motor Vehicle and Corresponding Heating, Ventilation and/or Air-Conditioning Facility

(71) Applicant: VALEO SYSTEMES THERMIQUES, Le Mesnil Saint Denis cedex (FR)

(72) Inventors: Frederic PIERRON, Rambouillet (FR); Jose LEBORGNE, Elancourt (FR); Laurent TELLIER, Paris (FR)

(21) Appl. No.: 14/902,054

(22) PCT Filed: Jun. 23, 2014
(86) PCT No.: PCT/EP2014/063196

§ 371 Date: Dec. 30, 2015

(30) Foreign Application Priority Data
Jul. 2, 2013 (FR) 1356423

(51) Int. Cl. B60H 1/22; H05B 3/50; F24H 3/08

(52) U.S. Cl. CPC B60H 1/2221; F24H 3/081; H05B 3/50; B60H 2001/2271; H05B 2214/02

(57) ABSTRACT

The invention relates to a thermal conditioning device for a fluid for a motor vehicle, said device comprising at least one thermal module (3a, 3b) comprising:—a core (11) comprising a core body (12), and—an enclosure (13a, 13b): able to be electrically powered so as to form a heat source and arranged around the core (11) so as to define a guide circuit (15) for the fluid to be thermally conditioned, the guide circuit (15) being defined between the body (12) of the core (11) and the enclosure (13a, 13b). According to the invention, the enclosure (13a, 13b) is arranged around the core (11) at a distance (e) from the body (12) of the core (11) comprised between 0.5 mm and 8 mm. The invention also relates to a heating and/or air conditioning apparatus comprising such a device.

The invention relates to a device for thermally conditioning a fluid, such as a device for electrically heating a fluid, for a motor vehicle. The invention applies more particularly to motor vehicle heating and/or air-conditioning units comprising such a heating device.

Air intended for heating the vehicle interior is usually warmed up by passing a flow of air through a heat exchanger, more specifically by exchange of heat between the flow of air and a fluid. This is generally the coolant in the case of a combustion engine.

Such a heating method may prove unsuitable or insufficient to guarantee heating of the interior of a motor vehicle as well as demisting and defrosting.

However, a method for rapidly and effectively heating up the interior of the vehicle, particularly for warming up the interior or for defrosting or demisting the vehicle prior to use in a very cold environment or even when a very rapid rise in temperature is desired.

Furthermore, in the case of an electric vehicle, the heating function is no longer performed by circulation of the coolant through the heat exchanger. However, a water circuit can be provided for heating the vehicle interior but this method of heating may likewise prove unsuitable or insufficient to guarantee rapid and effective heating of the vehicle interior.

Moreover, in order to reduce the size and cost of an additional water circuit, it is also known practice to use, for an electric vehicle, an air-conditioning loop that operates in a heat pump mode. Thus, the air-conditioning loop that conventionally allows a flow of air to be cooled using a refrigerant is used, in this case, to heat up the flow of air.

However, this method of heating may prove unsuitable or insufficient. This is because the performance of the air-conditioning loop in heat pump mode is dependent on the external weather conditions. For example, when the external air temperature is too low, this air cannot be used as a source of heat energy.

One known solution is to add an additional electrical heating device to the heat exchanger or to the water circuit or even to the air-conditioning loop.

The additional electrical heating device may be suitable for the upstream heating of the fluid, such as the engine coolant or the water of the electric vehicle interior heating water circuit or even the refrigerant of the air-conditioning loop.

In the known way, the additional electrical heating device comprises one or more heating modules in contact with the fluid that is to be heated.

In the case of a heating module comprising a heating tube without a core placed inside this heating tube, the fluid which is to be heated, such as water, may stagnate on the walls of the heating tube and start to boil. This is because the speed at which the fluid travels decreases with increasing distance away from the center of the heating tube.

According to one known solution, a heating module comprises a core and a heating element produced in the form of a shell, for example a cylindrical shell, surrounding the core, so as to define a guide circuit guiding the fluid between the core and cylindrical shell. The cylindrical shell is therefore the source of thermal energy. The heating element or shell may have electrical heating means for example one or more heating resistances produced with screen printing in the form of resistive tracks on the external surface of the heating element.

In this case, the speed at which the fluid passes is greater and the fluid near the internal walls of the shell is heated up without reaching boiling point.

However, if the volume of the guide circuit defined between the body of the core and the shell is too small, the speed at which the fluid passes increases, thus increasing pressure drops.

However, on the other hand, if the distance between the core and the heating shell is too great, that decreases the transfer of heat between the cylindrical shell and the fluid.

In order to increase the efficiency of the exchange of heat between the heating element and the fluid circulating between the core and the heating element, one known solution is to generate a helical movement of the fluid circulating in the guide circuit. This then increases the exchange of heat between the heating element, for example in the form of a cylindrical shell, and the fluid circulating inside this cylindrical shell.

To achieve this, it has been proposed for the core to have on its external surface a substantially helical groove. Such a core is therefore complicated to produce.

This helical groove makes it possible to force the fluid to adopt a swirling motion. However, with such a solution, it has been found that there is a lack of uniformity of the speeds at the inlet of the fluid guide circuit and a high pressure drop.

It is therefore an objective of the invention to propose a thermal conditioning device, notably an electrical heating device, that has an improved heat-exchange efficiency while at the same time reducing pressure drops.

To this end, one subject of the invention is a device for electrically thermally conditioning a fluid for a motor vehicle, said device comprising at least one thermal module comprising:
a core comprising a core body, and
a shell able to be electrically powered so as to form a thermal source, and arranged around the core so as to define a guide circuit for guiding the fluid that is to be thermally conditioned, the guide circuit being defined between the body of the core and the shell,
   characterized in that the shell is arranged around the core at a distance from the body of the core of between 0.5 mm and 8 mm.

The range of distances between the core and the shell makes it possible in a simple way to guarantee, in the case of a heating device, that the shell surrenders to the fluid a maximum of the thermal energy produced by the shell.

The device is equally applicable to the removal of heat from the fluid.

This device also has the advantage of creating very little by way of pressure drop in the fluid circuit at flow rates which may range up to 1000 l/h or even 1500 l/h.

Said device may further comprise one or more of the following features, considered separately or in combination:
the shell is arranged around the body of the core at a lateral distance with respect to the body of the core;
a thermal module extends along a longitudinal axis and the distance between the body of the core and the shell of a thermal module is substantially constant along the length of the shell;
the body of the core and the shell of a thermal module are respectively of substantially cylindrical shape;
the shell comprises at least one electric heating resistance;
the external surface of the body of the core is substantially smooth;
the core of a thermal module has a fluid inlet end and a fluid outlet end opposite the inlet end;
the core comprises a predefined number of spacers positioned between the body of the core and an inlet end or outlet end of the core;
said device is arranged in a heating circuit for heating the interior of said vehicle.

The invention also relates to a heating and/or air-conditioning unit for a motor vehicle, characterized in that it comprises a thermal conditioning device as defined hereinabove.

Further features and advantages of the invention will become more clearly apparent from reading the following description given by way of nonlimiting illustrative example and from studying the attached figures in which:

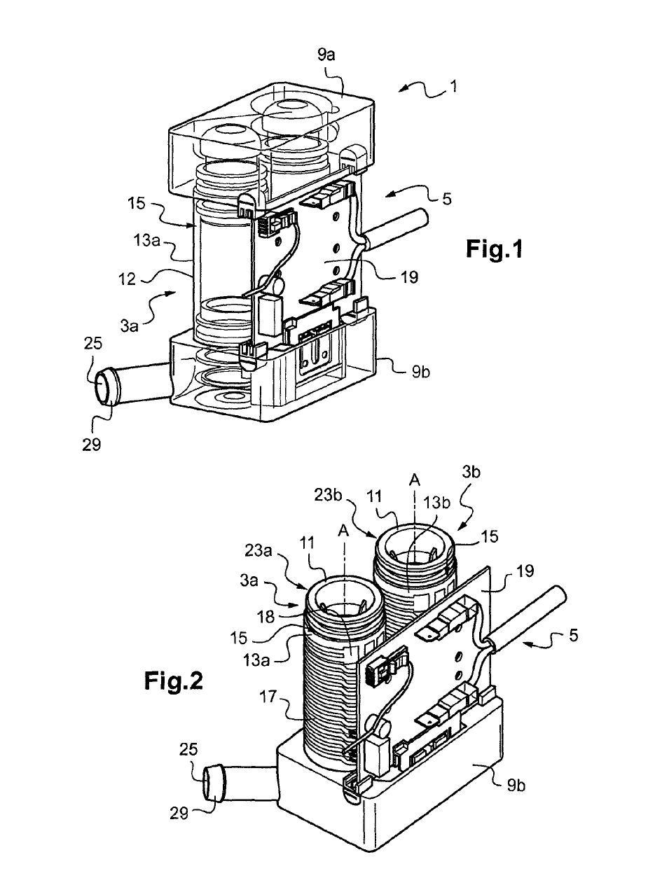

FIG. 1 is a perspective view of a device for electrically heating a fluid for a motor vehicle according to the present invention, depicted partially showing hidden detail,

FIG. 2 depicts the electrical heating device of FIG. 1 depicted in solid with a fluid outlet header removed,

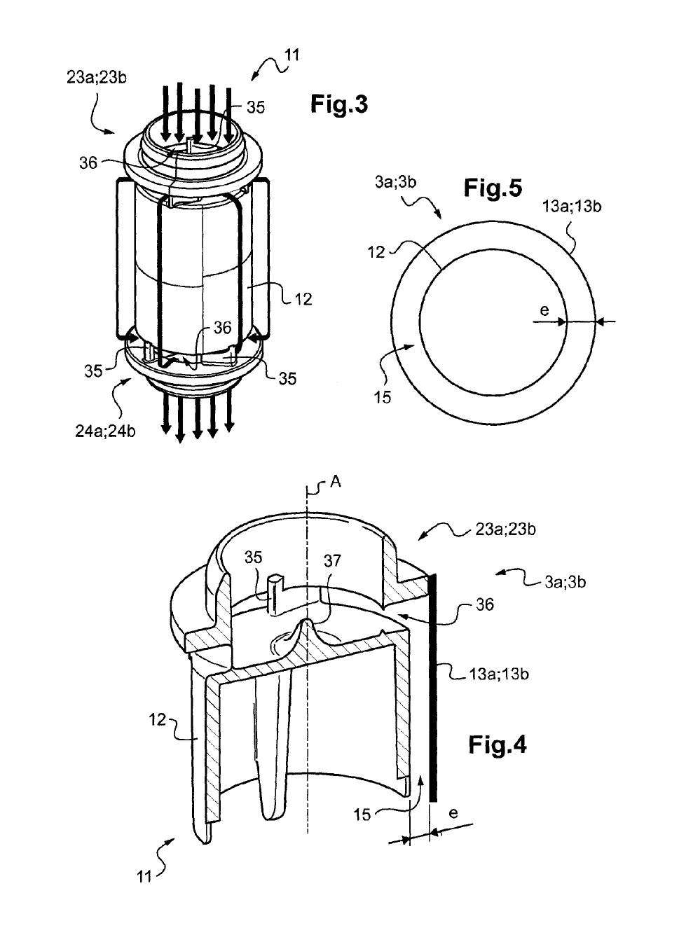

FIG. 3 schematically depicts the core of a heating module of the heating device,

FIG. 4 is a view in part section and perspective of the core of FIG. 3, and

FIG. 5 is a schematic plan view illustrating the body of the core of FIGS. 3 and 4 and a heating shell arranged around the body of the core.

In these figures, elements that are substantially identical bear the same references.

FIG. 1 depicts a thermal conditioning device 1 such as a device for electrically heating a fluid for a motor vehicle for a heating and/or air-conditioning unit.

The electrical heating device 1 is, for example, an additional heating device for heating a fluid arranged in a circuit for heating a fluid of the vehicle for heating the interior.

According to one example, the electrical heating device 1 is positioned upstream of a heat exchanger of an air-conditioning loop able to operate as a heat pump, so as to heat the refrigerant.

According to another example, the electrical heating device 1 is arranged upstream of a heat exchanger using a combustion engine coolant as heat-transfer fluid.

Such an electrical heating device 1 could also be provided upstream of a heat exchanger intended to regulate the temperature of an electrical energy storage device sometimes termed a battery pack for an electrically-powered or hybrid vehicle.

The invention may also be applied to a device for cooling a fluid.

The electrical heating device 1 depicted comprises at least one heating module 3a, 3b, in this instance a first heating module 3a and a second heating module 3b.

Of course provision may be made for the electrical heating device to comprise a single heating module, or several heating modules, depending on the requirements.

The electrical heating device 1 may also comprise a control means 5 for controlling the supply of electrical power to the heating modules 3a, 3b.

In addition, the electrical heating device 1 may comprise a fluid inlet header 9b fluidically communicating (which means to say that there is a communication via a fluid) with the heating modules 3a, 3b for the admission of the fluid that is to be heated, and a fluid outlet header 9a communicating fluidically with the heating modules 3a, 3b, for discharging the heated fluid.

With reference to FIG. 2, a heating module 3a, 3b comprises:
a core 11 having a core body 12, and
a shell 13a, 13b arranged in such a way as to surround the body 12 of the core 11.

The heating module 3a, 3b may be of substantially longitudinal shape and extend along a longitudinal axis A.

In the example illustrated, the core 11 and the shell 13a, 13b are, for example, respectively of substantially cylindrical shape and extend along the longitudinal axis A. The core 11 and the shell 13a, 13b may be concentric.

The heating module 3a, 3b therefore has a substantially cylindrical shape defined by the shell 13a, 13b.

The core 11 and the shell 13a, 13b define a guide circuit 15 guiding the fluid that is to be heated, such as liquid.

According to the embodiment illustrated in FIGS. 1 and 2, each heating module 3a, 3b comprises a guide circuit 15 guiding the fluid between the core 11 and the respective shell 13a, 13b.

More specifically, the core 11, better visible in FIGS. 3 and 4, has a core 11 body 12 defining the guide circuit 15.

The guide circuit 15 is defined around the external surface of the body 12 of the core 11 and is therefore on the outside of the core 11 and on the inside of the associated shell 13a or 13b of a heating module 3a, 3b. In other words, the external surface of the body 12 of the core 11 and the internal surface of the associated shell 13a or 13b define a volume in which the fluid to be heated circulates around the core 11.

The external surface of the body 12 of the core may be substantially smooth, which means to say free of grooves or ribs designed to cause the fluid to execute a particular movement around the core 11.

As an alternative, means for disrupting the flow of fluid may be provided on the external surface of the body 12 of the core 11 in order to improve the exchange of heat; by way of example, a pocketed or even ribbed external surface may be provided.

Furthermore, the shell 13a, 13b associated with the core 11 of a heating module 3a, 3b is arranged around the body 12 of the core 11 with a distance e depicted schematically in FIGS. 4 and 5, of between 0.5 mm and 8 mm. This is a lateral distance e in the example illustrated.

This distance e forms a separation between the external surface of the body 12 of the core and the internal surface of the shell 13a, 13b, making it possible to define the volume of the guide circuit 15.

The distance e is constant over the entire length of the shell 13a, 13b in the example illustrated, which means that the volume of the guide circuit 15 is constant.

In addition, the range of 0.5 mm to 8 mm offers an advantageous compromise in terms of heat exchange versus pressure drop.

Specifically, with a narrow fluid guide circuit the speed at which the fluid passes increases, and with increasing speed comes increasing pressure drop. On the other hand, with too large a guide circuit for the fluid that is to be heated, the pressure drops decrease but the exchange of heat between the fluid and the shell is inefficient.

The range of distances between the body 12 of the core and the associated shell 13a, 13b of 0.5 mm to 8 mm defining the volume of the guide circuit offers satisfactory exchange of heat between the fluid and the shell 13a, 13b while at the same time minimizing pressure drops. The volume of the guide circuit 15 thus defined is small enough that the fluid can pass sufficiently quickly and absorb heat and large enough that pressure drops decrease.

This range therefore defines a volume of guide circuit 15 that always allows heat to be transferred between the shell 13a, 13b and the fluid circulating in the guide circuit 15 while at the same time minimizing pressure drops.

Moreover, in order to allow fluid to be admitted to a heating module 3a, 3b, the core 11 of the heating module 3a, 3b may have a fluid inlet end 23a, 23b fluidically communicating with the inlet header 9b and the guide circuit 15 between the core 11 and the associated shell 13a, 13b.

In the example illustrated, an inlet end 23a, 23b of the core 11 of a heating module 3a, 3b may have an opening which defines a fluid passage section for admitting fluid to the guide circuit 15 of the associated heating module 3a, 3b. The opening may be centralized and large so as to allow the fluid to be distributed uniformly to the guide circuit 15.

Because of the cylindrical shape of the core 11, the inlet end 23a, 23b may be of substantially annular shape. In that case, the distribution of the fluid is substantially annular and uniform as illustrated by the arrows in FIG. 3.

Likewise, to allow the fluid to be discharged from the heating module 3a, 3b, the core 11 of the heating module 3a, 3b may have a fluid outlet end 24a, 24b fluidically communicating with the outlet header 9a and the guide circuit 15 between the core 11 and the associated shell 13a, 13b. The outlet end 24a, 24b allows the fluid that has circulated through the guide circuit 15 to be discharged from the heating module 3a, 3b.

To this end, the outlet end 24a, 24b may also have an opening 26 in fluidic communication with the guide circuit 15 and defining a passage section for the fluid that has circulated through the guide circuit 15 and needs to be discharged.

The outlet end 24a, 24b of the core 11 of a heating module 3a, 3b may be substantially symmetric with respect to the inlet end 23a, 23b. As a result, the outlet end 24a, 24b may likewise be of substantially annular shape.

Furthermore, the inlet end 23a, 23b and the outlet end 24a, 24b of a heating module 3a, 3b are opposed, more specifically longitudinally opposed.

Thus, the fluid from the fluid inlet header 9b can circulate through the circulation volume defined by the guide circuit 15 between the core 11 and the associated shell 13a, 13b of a heating module 3a, 3b by being introduced via the defined fluid-passage opening of the inlet end 23a, 23b. Further, at the fluid outlet, the fluid that has circulated through the guide circuit 15 is directed toward the outlet end 24a, 24b of the core 11 so that it can be discharged via the outlet header 9a.

In addition, a heating module 3a, 3b may comprise a predefined number of spacers 35 arranged between the inlet end 23a, 23b of the core 11 and the core body 12.

By way of example, the spacers 35 may be arranged on the external periphery of the end surface of the body 12 of the core facing the inlet end 23a, 23b and on the external periphery of the inlet edge 23a, 23b opposite.

The spacers 35 may be evenly distributed at a predefined angular spacing. Of course, the spacers 35 may be unevenly distributed.

Advantageously, such spacers 35 may belong to the core 11 and be produced as one piece with the core 11 of the heating module 3a, 3b.

The spacers 35 make it possible to define lateral windows 36 via which the fluid admitted via the fluid-passage opening of the inlet end 23a, 23b of the core 11 reaches the guide circuit 15 defined between the core body 12 and the associated shell 13a, 13b. The windows 36 therefore provide fluidic communication between the fluid-passage opening of the inlet end 23a, 23b and the guide circuit 15.

Fluid arriving via the inlet end 23a, 23b of the core 11 is directed toward the guide circuit 15 defined between the external surface of the body 12 of the core 11 and the internal surface of the shell 13a, 13b and wets the entirety of the surface of the whole guide circuit 15.

Similarly, such spacers 35 may be provided between the body 12 of the core 11 and the output end 24a, 24b, thereby defining windows 36 via which the fluid that has circulated through the guide circuit 15 reaches the fluid passage opening of the output end 24a, 24b. In that case, the windows 36 provide fluidic communication between the guide circuit 15 and the fluid-passage opening of the outlet end 24a, 24b.

The circulation of the fluid from the inlet end 23a, 23b of the core 11 of a heating module 3a, 3b, through the guide circuit 15, then through the outlet end 24a, 24b is indicated schematically by arrows in FIG. 3.

According to the depiction illustrated in FIG. 3, the fluid follows a linear movement through the guide circuit 15, substantially parallel to the longitudinal axis A.

As an alternative, a different movement, for example a swirling or helical movement, of the fluid may be generated upstream of the fluid guide circuit 15. In that case, the spacers 35 may be arranged following the movement, for example the swirling, of the fluid about the axis A, so that this movement of the fluid continues along the guide circuit 15 around the core 11.

The spacers 35 therefore lie in the path of the fluid and carry the risk of disrupting the flow of the fluid.

In order to alleviate this disadvantage, the spacers 35 are advantageously arranged and configured in such a way as not to “break” the movement of the fluid.

The spacers 35 may additionally have a deflector function, being arranged in such a way as to guide the fluid arriving at the inlet end 23a, 23b of the core 11 toward the guide circuit 15.

Conversely, the spacers 35 arranged between the body 12 of the core and the outlet end 24a, 24b of the core 11 may have a deflector function and guide the fluid that has circulated through the guide circuit 15 toward the outlet end 24a, 24b.

In the example illustrated in FIGS. 3 and 4, the spacers 35 are produced in the form of substantially convex tabs, or in the form of vanes.

According to the example illustrated, the core 11 may also comprise a central deflector 37 positioned substantially at the center of the end surface of the body 12 of the core facing the inlet end 23a, 23b of the core 11. The central deflector 37 also contributes to guiding and distributing the flow of fluid admitted by the inlet end 23a, 23b of the core 11 toward the guide circuit 15 via the windows 36.

The central deflector 37 has, for example, a substantially rounded nipple shape.

Symmetrically, a central deflector 37 may be positioned on the end surface of the body 12 of the core facing the outlet end 24a, 24b of the core 11.

The shell 13a, 13b can be electrically powered and when electrically powered forms a thermal source, for example a heating source in the case of a heating module 3a, 3b. The shell 13a, 13b is then referred to as the heating shell 13a, 13b.

The shell 13a, 13b is controlled by the control means 5 (FIG. 2) in order in the example described to heat the fluid circulating in the guide circuit 15 by exchange of heat between the heating shell 13a, 13b and the fluid.

According to the embodiment illustrated in FIG. 2, a shell 13a, 13b has at least one electrical heating means such as a heating resistance 17. A heating resistance 17 may be produced in the form of a resistive track 17. According to the embodiment depicted, a heating shell 13a, 13b has two electrical heating means produced in the form of two resistive tracks 17.

The two resistive tracks 17 may run parallel at least partially over the height of the shell 13a, 13b. The two resistive tracks 17 are, for example, imbricated in one another or interlaced.

The resistive tracks 17 are, for example, produced by screen-printing on the external surface of the shell 13a, 13b, namely on the opposite surface to the internal surface of the shell 13a, 13b facing the body 12 of the core 11 defining the guide circuit 15. The resistive tracks 17 are therefore outside of the guide circuit 15 guiding the fluid that is to be heated.

By virtue of this embodiment, the heat produced by the resistance or resistances 17 is transmitted directly to the fluid that is to be heated through the wall of the corresponding heating shell 13a or 13b, thereby minimizing thermal losses and reducing the thermal inertia of the device so that the fluid can be heated rapidly.

The control means 5 in this case controls the heating shells 13a, 13b by controlling the supply of power to the heating resistances 17, which in this example are produced in the form of resistive tracks 17.

To this end, the resistive tracks 17 are connected to the control means 5. Connection terminals 18 electrically connected to the ends of the resistive tracks 17 are provided for this purpose. The control means 5 is electrically connected to these connection terminals 18.

Furthermore, a temperature sensor (not depicted in the figures) may be provided for measuring the temperature of an associated heating element 13a, 13b. This may be a thermistor, such as an NTC (negative temperature coefficient) probe the resistance of which decreases uniformly with temperature. This temperature sensor may be brazed or soldered to the external surface of the associated shell 13a, 13b.

In this case, the control means 5 controls the supply of power to the heating resistances 17 according to a heating instruction and according to the temperature measured by the temperature sensor.

The control means 5 controlling the shell 13a, 13b may comprise an electric circuit support 19, such as a printed circuit board (or PCB). The electric circuit support 19 carries electronic and/or electrical components. One or more electric current switches for controlling the supply of electrical power to the heating elements 13a, 13b, a microcontroller, electrical connectors connecting the heating resistances 17 to the electric current switches, high-voltage power connectors and a low-voltage power connector and data buses are notable examples of these.

Means of positioning the electric circuit support 19, such as clip-fastening means, arranged for example at the four corners of the electric circuit support 19 may also be provided.

Moreover, in the case of a heating device 1 comprising several heating modules, two in the example illustrated, these heating modules 3a, 3b may be identical.

According to the embodiment illustrated, the two heating modules 3a, 3b are positioned side by side substantially parallel.

Of course, other arrangements are conceivable, for example positioning the two heating modules 3a, 3b end to end in the longitudinal direction of the heating modules 3a, 3b.

The side-by-side arrangement makes it possible to reduce the overall size of the heating device 1 in the longitudinal direction. In addition, this arrangement has a low heating inertia and a low pressure drop.

Moreover, insofar as the fluid inlet and outlet headers 9a, 9b are concerned, as may be seen in FIG. 1, the fluid outlet header 9a may have substantially the same shape as the fluid inlet header 9b.

The inlet 9b and outlet 9a headers are, according to this example, connected up symmetrically, at the two opposite ends of the heating modules 3a, 3b.

According to the embodiment illustrated, the two, inlet and outlet, headers 9b, 9a respectively comprise a fluid circulation pipe 25 for admitting or discharging the fluid, communicating with the guide circuit 15 of the first heating module 3a and with the guide circuit 15 of the second heating module 3b.

The fluid inlet and outlet headers 9b, 9a also comprise a projecting fluid intake or discharge nozzle 29. The nozzle 29 of each header 9a, 9b is common to the two heating modules 3a, 3b.

Fluid thus flows from the fluid intake nozzle 29 of the inlet header 9b, into the fluid circulation pipe 25 of the inlet header 9b, then in parallel into the guide circuits 15 of the heating modules 3a, 3b and reemerges in the fluid circulation pipe 25 of the outlet header 9a then into the nozzle 29 for discharging the fluid from the outlet header 9a.

It will therefore be appreciated that a heating module 3a, 3b comprising a core 11 as defined hereinabove and a heating shell 13a, 13b arranged around the core 11 at a distance e of the order of 0.5 mm to 8 mm from the body 12 of the core 11 makes it possible to achieve good exchange of heat between the fluid that is to be heated and the heating shell 13a, 13b in order to meet the demanded heating requirement while at the same time minimizing pressure drops.

Furthermore, the core 11 with an inlet end 23a, 23b as described hereinabove defining a central and large passage section for admitting fluid to the guide circuit 15 allows uniform distribution of the fluid that is to be heated in the guide circuit 15 and thus contributes to improving the exchange of heat between the fluid circulating through this guide circuit 15 and the heating shell 13a, 13b.

1. A device (1) for electrically thermally conditioning a fluid for a motor vehicle, said device (1) comprising at least one thermal module (3a, 3b) comprising:
a core (11) comprising a core body (12), and
a shell (13a, 13b):
adapted to be electrically powered so as to form a thermal source, and
arranged around the core (11) so as to define a guide circuit (15) for guiding the fluid that is to be thermally conditioned, the guide circuit (15) being defined between the body (12) of the core (11) and the shell (13a, 13b),
wherein the shell (13a, 13b) is arranged around the core (11) at a distance (e) from the body (12) of the core (11) of between 0.5 mm and 8 mm.

2. The device (1) as claimed in claim 1, in which the shell (13a, 13b) is arranged around the body (12) of the core (11) at a lateral distance (e) with respect to the body (12) of the core (11).

3. The device (1) as claimed in one of claim 1, in which a thermal module (3a, 3b) extends along a longitudinal axis (A) and the distance (e) between the body (12) of the core (11) and the shell (13a, 13b) of the thermal module (3a, 3b) is substantially constant along the length of the shell (13a, 13b).

4. The device (1) as claimed in claim 1, in which the body (12) of the core (11) and the shell (13a, 13b) of a thermal module (3a, 3b) are respectively of substantially cylindrical shape.

5. The device (1) as claimed in claim 1, in which the shell (13a, 13b) comprises at least one electric heating resistance.

6. The device (1) as claimed in claim 1, in which the external surface of the body (12) of the core (11) is substantially smooth.

7. The device (1) as claimed in claim 1, in which the core (11) of a thermal module (3a, 3b) has a fluid inlet end (23a, 23b) and a fluid outlet end (24a, 24b) opposite the inlet end (23a, 23b).

8. The device (1) as claimed in claim 7, in which the core (11) comprises a predefined number of spacers (35) positioned between the body of the core (12) and the fluid inlet end (23a, 23b) or fluid outlet end (24a, 24b) of the core (11).

9. The device (1) as claimed in claim 1, arranged in a heating circuit for heating the interior of the vehicle.

10. A heating and/or air-conditioning unit for a motor vehicle, comprising at least one thermal conditioning device (1) as claimed in claim 1.

11. The device (1) as claimed in one of claim 2, in which a thermal module (3a, 3b) extends along a longitudinal axis (A) and the distance (e) between the body (12) of the core (11) and the shell (13a, 13b) of the thermal module (3a, 3b) is substantially constant along the length of the shell (13a, 13b).

12. The device (1) as claimed in claim 11, in which the body (12) of the core (11) and the shell (13a, 13b) of a thermal module (3a, 3b) are respectively of substantially cylindrical shape.

13. The device (1) as claimed in claim 3, in which the body (12) of the core (11) and the shell (13a, 13b) of a thermal module (3a, 3b) are respectively of substantially cylindrical shape.
